(19) United States
(12) Patent Application Publication
(10) Pub. No.: US 2025/0376233 A1
(43) Pub. Date: Dec. 11, 2025

(54) REDUCTION-WARNING SYSTEM

(71) Applicant: Enerstro Tech. Corp., Yunlin County (TW)

(72) Inventor: PO-JU LIN, Yunlin County (TW)

(21) Appl. No.: 18/733,888

(22) Filed: Jun. 5, 2024

(51) Int. Cl. B62J 50/21; B62J 45/413

(52) U.S. Cl. CPC B62J 50/21; B62J 45/413

(57) ABSTRACT

A reduction-warning method includes the steps of providing a bicycle with a crankshaft, detecting a rotational rate of the crankshaft, determining whether the rotational rate of the crankshaft is reduced, returning the step of detecting the rotational rate, and providing an alert if the rotational rate of the crankshaft is reduced.

### BACKGROUND OF THE INVENTION

The present invention relates to a bicycle and, more particularly, to a reduction-warning system for a bicycle.

### SUMMARY OF THE INVENTION

It is the primary objective of the present invention to provide a bicycle with a reduction-warning system when the bicycle is not driven manually or electrically.

To achieve the foregoing objective, the reduction-warning method includes the steps of providing a bicycle with a crankshaft, detecting a rotational rate of the crankshaft, determining whether the rotational rate of the crankshaft is reduced, returning the step of detecting the rotational rate, and providing an alert if the rotational rate of the crankshaft is reduced.

Other objectives, advantages and features of the present invention will be apparent from the following description referring to the attached drawings.

### PRIOR ART

There are various two-wheeled vehicles such as motorcycles, scooters, electric scooters, electric bicycles, bicycles and electrically assisted bicycles. In Taiwan, an electric scooter is capable of running faster than 25 kilometers per hour and an electric bicycle is not allowed to run faster than 25 kilometers per hour. An electrically assisted bicycle is manually propelled most of the time and is manually and electrically propelled if necessary.

An electric scooter or an electric bicycle is equipped with a reduction-warning system to give a warning to a following rider or driver when it is braked. Thus, risks of the electric scooter or electric bicycle being hit by a following vehicle are reduced. However, the reduction-warning system fails to give a warning to a following rider or driver when it is relaxed but not braked. Thus, risks of the electric scooter or electric bicycle being hit by the following vehicle are not reduced.)

An electrically assisted bicycle is not provided with any reduction-warning system. Hence, the electrically assisted bicycle can be hit by a following vehicle when the electrically assisted bicycle is relaxed or braked. Thus, risks of the electrically assisted bicycle being hit by the following vehicle are not reduced.)

The present invention is therefore intended to obviate or at least alleviate the problems encountered in the prior art.

### BRIEF DESCRIPTION OF DRAWINGS

The present invention will be described via detailed illustration of the preferred embodiment referring to the drawings wherein:

FIG. 1 is a flow chart of a reduction-warning method according to the preferred embodiment of the present invention;

FIG. 2 is a side view of an electrically assisted bicycle for which the reduction-warning method shown in FIG. 1 is executable;

FIG. 3 is a partial and exploded view of the electrically assisted bicycle shown in FIG. 2;

FIG. 4 is a cross-sectional view of the electrically assisted bicycle shown in FIG. 3;

FIG. 5 is a partial and top view of the electrically assisted bicycle shown in FIG. 2 and a reduction-warning device; and

FIG. 6 is a top view of the electrically assisted bicycle shown in FIG. 2 followed by two bicycles.

### DETAILED DESCRIPTION OF THE INVENTION

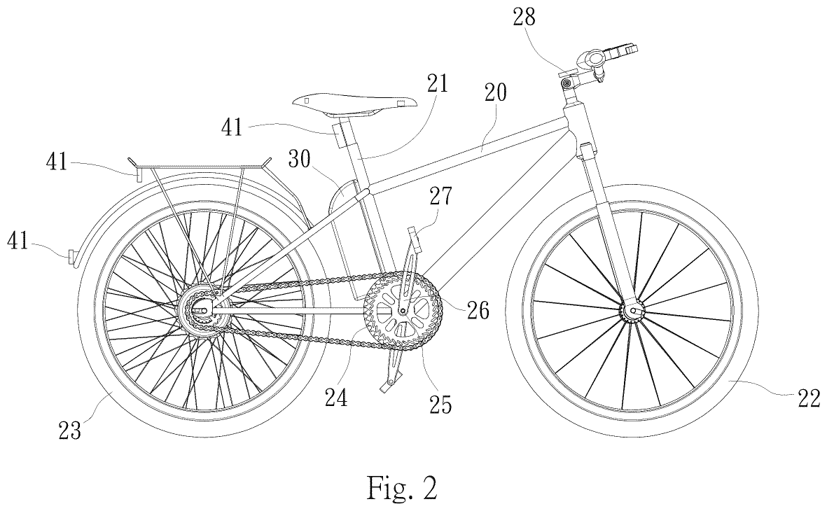

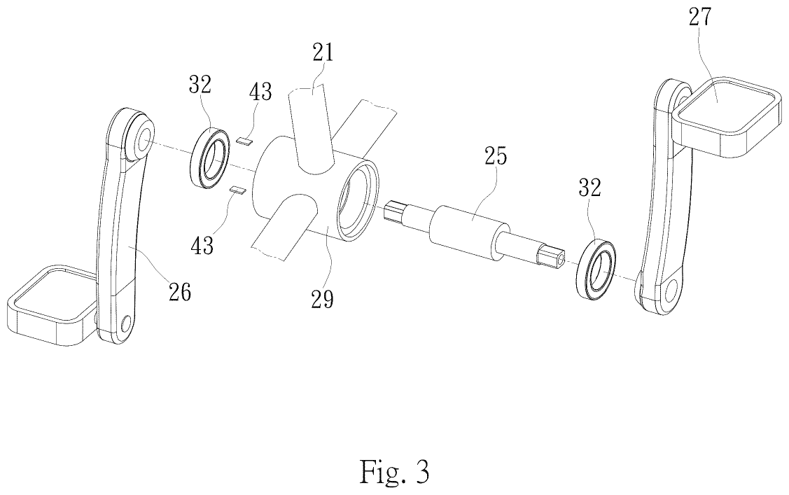

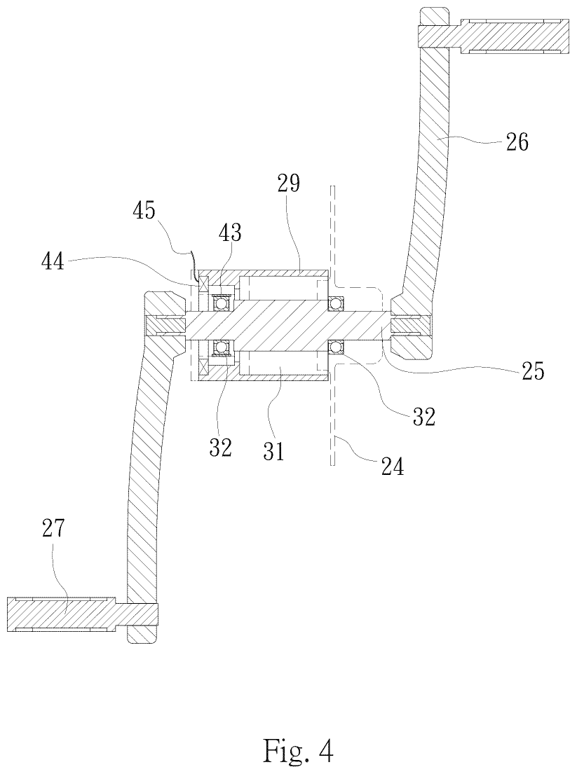

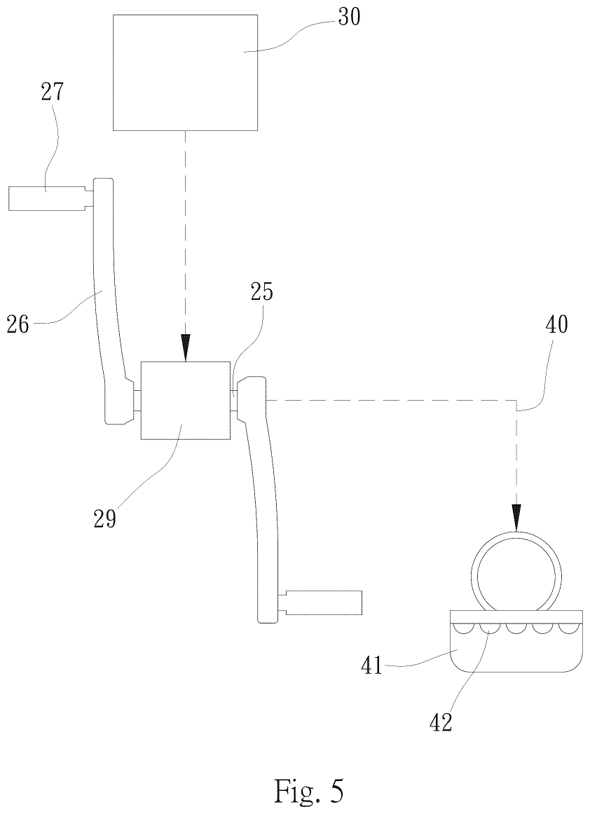

Referring to FIGS. 2 through 5, an electrically assisted bicycle 20 includes a frame 21, a fork (not numbered), a front wheel 22, a rear wheel 23, a crankshaft, two pedals 27, a dashboard 28, an electric-assistance device (not numbered), a transmission system (not numbered) and a reduction-warning device 40 according to the preferred embodiment of the present invention.)

The frame 21 is formed with a bottom bracket 29. The bottom bracket 29 is in the form of a tube with two open ends.)

The front wheel 22 is connected to the fork, which is connected to a front end of the frame 21. The rear wheel 23 is connected to a rear end of the frame 21.

The crankshaft includes an axle 25 and two cranks 26. The axle 25 extends throughout the bottom bracket 29. The axle 25 includes a middle section extending in the bottom bracket 29 and two ends extending from the bottom bracket 29. The middle section of the axle 25 is spinnable in the bottom bracket 29 for using two bearings 32. Each of the cranks 26 includes an end connected to a corresponding one of the ends of the axle 25 and another end connected to a corresponding one of the pedals 27.)

The transmission includes a chain ring 24, a flywheel (not numbered) and a chain (not numbered). Preferably, the chain ring 24 is connected to one of the cranks 26. The flywheel is connected to the rear wheel 23. The chain is wound on the chain ring 24 and the flywheel. A rider treads the pedals 27 to spin the crankshaft so that the chain ring 24 spins the flywheel through the chain so that the rear wheel 23 spins to move the bicycle 20. The faster the crankshaft spins, the faster the bicycle 20 moves.)

The electric-assistance device includes a power supply 30, a motor 31 and a clutch (not shown). The power supply 30 is supported on the frame 21. The motor 31 is electrically connected to the power supply 30. Preferably, the motor 31 is located in the bottom bracket 29. The clutch is arranged between the motor 31 and the axle 25. Thus, the motor 31 is allowed to spin the axle 25 via the clutch. Thus, the electrically assisted bicycle 20 is drivable electrically in addition to manually.)

The reduction-warning system 40 includes an alarm element 41, two sensors 43 and a controller 44.)

The alarm element 41 is supported on the frame 21, a seat post (not numbered), a saddle (not numbered), a rack (not shown) or a mudguard (not shown) for example. The alarm element 41 is directed backwards. Preferably, the alarm element 41 includes multiple light-emitting diodes 42 electrically connected to the power supply 30. Thus, the alarm element 41 is operable to provide a ray of light or flashes of light.)

The sensors 43 are located in the bottom bracket 29. Preferably, the sensors 43 are located on an external side of one of the bearings 32. Preferably, the sensors 43 are pressure or force sensors.

The sensors 43 can be capacitive sensors for example. Forces exerted on the pedals 27 are transferred to the axle 25 via the cranks. Accordingly, the bearings 32 is pressed against the bottom bracket 29. Changes in the forces exerted on the pedals 27 entail changes in the capacitance of the sensors 43.)

Alternately, the sensors 43 can be resistive sensors or piezoelectric sensors.

Preferably, the controller 44 is located in the bottom bracket 29. At least one wire 45 electrically connects the controller 44 to the power supply 30 so that the power supply 30 is operable to energize the controller 44. The controller 44 is electrically connected to the sensors 43 so that the controller 44 is operable to communicate with the sensors 43. The controller 44 preferably includes a programmable logic controller.)

The dashboard 28 is supported on stem (not numbered) or a handlebar (not numbered) of the electrically assisted bicycle 20. The user is allowed to observe the dashboard 28 to know information about the electrically assisted bicycle 20 such as the coordinate, the distance traveled, and the energy level of the power supply 30.)

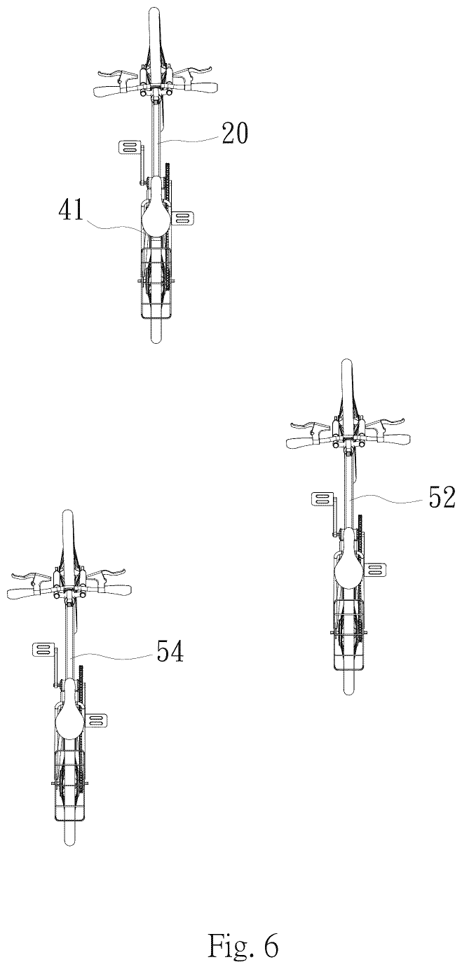

Referring to FIG. 6, the electrically assisted bicycle 20 is followed by two bicycles 52 and 54. Normally, the reduction-warning system 40 does not provide any alert.)

The bicycles 52 and 54 approach the electrically assisted bicycle 20 when the rotational rate of the electrically assisted bicycle 20 is reduced. The reduction-warning system 40 provides an alert for riders on the bicycles 52 and 54, thereby reminding the riders on the bicycles 52 and 54 of slowing the bicycles 52 and 54.

The bicycles 52 and 54 fall behind the electrically assisted bicycle 20 when the electrically assisted bicycle 20 is accelerated. Now, there is no need for the reduction-warning system 40 to provide any alert.

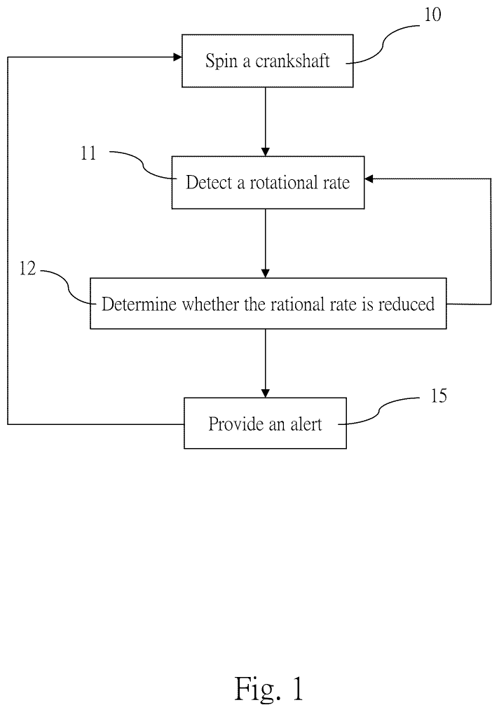

Referring to FIG. 1, there is a reduction-warning method according to the preferred embodiment of the present invention. The reduction-warning method is executed for the electrically assisted bicycle 20 for example to warn a rider or driver of a following vehicle of possible reduction of speed.

At 10, the electrically assisted bicycle 20 is provided with the crankshaft, which includes the axle 25 and the cranks 26.

At 11, the rotational rate of the crankshaft is detected. The detection is executed by the sensor 43 such as, but not limited to, a mechanical sensor. The sensor 43 detects the rotational rate and accordingly provides a value of capacitance, resistance or voltage.

At 12, it is determined whether the rotational rate is reduced. The process goes to 15 if the rotational rate is reduced or 11 if the rotational rate is not reduced.

At 15, an alert or warning is provided. The alert is in the form of light and/or sound. In the case of light, flashes of red, orange or yellow light are preferred. In the case of sound, a continuous sound is preferred. Alternatively, a recorded sound “slowing” can be replayed.)

The reduction of the rotational rate does not mean that the rider intends to use a brake of the bicycle. Hence, no brake light is actuated. The reduction of the rotational rate means that the rider intends not to accelerate the bicycle. The reduction-warning method is executed to show this intention of the rider to the following rider or driver.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A reduction-warning method comprising the steps of:
providing a bicycle with a crankshaft;
detecting a rotational rate of the crankshaft;
determining whether the rotational rate of the crankshaft is reduced;
returning the step of detecting the rotational rate; and
providing an alert if the rotational rate of the crankshaft is reduced.

2. The reduction-warning method according to claim 1, wherein the alert is selected from the group consisting of light and sound.

3. A reduction-warning system comprising:
an alarm element connected to a bicycle;
a sensor for detecting a rotational rate of an axle of the bicycle; and
a controller for actuating the alarm element to provide an alert when the rotational rate detected by the sensor is reduced.

4. A reduction-warning system according to claim 3, wherein the sensor is selected from the group consisting of a capacitive sensor, a resistive sensor and a piezoelectric sensor.

5. An electrically-assisted bicycle comprising
a frame comprising a bottom bracket;
an axle extending throughout the bottom bracket;
two bearings for rotationally supporting a middle section of the axle in the bottom bracket; and
a reduction-warning system comprising:
an alarm element connected to a bicycle;
a sensor for detecting a rotational rate of the axle; and
a controller for actuating the alarm element to provide an alert when the rotational rate detected by the sensor is reduced.
